(19) United States
(12) Patent Application Publication
(10) Pub. No.: US 2023/0170469 A1
(43) Pub. Date: Jun. 1, 2023

(54) METHOD OF MANUFACTURING GRANULATED MATERIAL AND METHOD OF MANUFACTURING ELECTRODE

(71) Applicant: TOYOTA JIDOSHA KABUSHIKI KAISHA, Toyota-shi (JP)

(72) Inventors: Takenori IKEDA, Owariasahi-shi (JP); Satoshi MORIYAMA, Nagoya-shi (JP); Shugo DAIKUHARA, Nisshin-shi (JP); Yuta KAWAMOTO, Kariya-shi (JP); Keigo OYAIZU, Kariya-shi (JP); Suguru NOMIMURA, Kariya-shi (JP)

(21) Appl. No.: 17/933,497

(22) Filed: Sep. 20, 2022

(30) Foreign Application Priority Data
Nov. 29, 2021 (JP) 2021-193166

(51) Int. Cl. H01M 4/36; H01M 4/505; H01M 4/525; H01M 4/62; H01M 4/04

(52) U.S. Cl. CPC H01M 4/366; H01M 4/505; H01M 4/525; H01M 4/623; H01M 4/0435

(57) ABSTRACT

A method of manufacturing a granulated material containing an electrode active material, a binder, and a solvent is provided. The electrode active material has at least one type of functional group selected from hydroxy group, carbonyl group, and carboxyl group on its surface.

### CROSS-REFERENCE TO RELATED APPLICATION

This application claims priority to Japanese Patent Application No. 2021-193166 filed on Nov. 29, 2021, incorporated herein by reference in its entirety.

### BACKGROUND

### 1. Technical Field

The disclosure relates to a method of manufacturing granulated material and a method of manufacturing electrodes.

### 2. Description of Related Art

For example, in Japanese Unexamined Patent Application Publication No. 2018-032604 (JP 2018-032604 A), an electrode manufacturing method is known in which sheet-like electrodes used in lithium-ion secondary batteries, etc. are produced by a method (granulated material forming method), specifically, by preparing granulated material containing electrode composite material, forming the granulated material into an electrode composite layer, and placing the electrode composite layer on an electrode current collector.

### SUMMARY

When producing electrodes by the granulated material forming method, further improvements in the productivity are required. To improve the productivity, it is desirable to improve the spreadability of the granulated material.

The disclosure provides a method of manufacturing granulated material, which makes it possible to produce granulated material having improved spreadability.

A method of manufacturing a granulated material according to the disclosure is a method of manufacturing a granulated material containing an electrode active material, a binder, and a solvent. The electrode active material is prepared such that at least one type of functional group selected from hydroxy group, carbonyl group, and carboxyl group is included on a surface of the electrode active material.

According to the manufacturing method as described above, the granulated material having improved spreadability can be prepared. Namely, the electrode active material has at least one type of functional group selected from hydroxy group (—OH), carbonyl group (═CO), and carboxyl group (—COOH) on its surface, which improves the wettability of the surface of the electrode active material. Thus, in the granulated material, the area of a portion that is wet with the solvent (or a mixture of the solvent and the binder), out of the surface of the electrode active material, is increased, so that the spreadability of the electrode active material is improved.

The method of the disclosure may further include performing plasma treatment on the electrode active material. By performing plasma treatment on the electrode active material, at least one type of functional group selected from the hydroxy group, carbonyl group, and carboxyl group is formed on the surface of the electrode active material, due to a trace amount of organic matter attached to the surface of the electrode active material.

In the method of the disclosure, the granulated material may have a solid content percentage that is equal to or greater than 75 mass % and is equal to or less than 90 mass %. In this case, the granulated material has good spreadability and good liquid retainability, which facilitates the manufacture of electrodes using the granulated material, and improves productivity in the manufacture of electrodes.

A method of manufacturing an electrode according to the disclosure includes preparing a granulated material containing an electrode active material, a binder, and a solvent, preparing the electrode active material such that at least one type of functional group selected from hydroxy group, carbonyl group, and carboxyl group is included on a surface of the electrode active material, performing compression molding on the granulated material with a pair of rolls, to form an electrode composite layer, and placing the electrode composite layer on an electrode current collector.

The electrode manufacturing method of the disclosure more reliably improves the spreadability of the granulated material, and facilitates the manufacture of electrodes using the granulated material.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a flowchart schematically showing a method of manufacturing electrodes in an embodiment;

FIG. 2 is a conceptual diagram showing an apparatus used for the manufacture of electrodes in the embodiment;

FIG. 3 is a schematic perspective view showing the apparatus used for the manufacture of electrodes in the embodiment;

FIG. 4 is a schematic view showing one example of an electrode sheet;

FIG. 5 is a graph showing the relationship between the solid content percentage, spreadability, and liquid retainability, for granulated materials of Comparative Examples;

FIG. 6 is a graph showing the relationship between the solid content percentage, spreadability, and liquid retainability, for granulated materials of Examples and Comparative Examples; and

FIG. 7 is a schematic view showing a measurement device for measuring the spreadability evaluation value.

### DETAILED DESCRIPTION OF EMBODIMENTS

One embodiment of the disclosure will be described. However, the disclosure is not limited to the embodiment. In this specification, “positive electrode” and “negative electrode” will be collectively referred to as “electrode”.

### Method of Manufacturing Granulated Material

In a method of manufacturing granulated material according to this embodiment, granulated material (wet granulated material) containing electrode active material, binder, and solvent is prepared. The granulated material is an aggregate of a plurality of granulated particles (composite particles) including the electrode active material, binder, and solvent.

For example, the granulated material can be prepared by mixing (granulating) the electrode active material, binder, solvent, etc. For example, an agitation granulation method can be used as a granulation method. Various granulation operations used in the process of preparing the granulated material include, for example, agitation granulation, fluidized bed granulation, and rolling granulation. Various types of granulation devices, such as an agitation mixing device, can be used for the granulation operations. When the agitation mixing device has agitating blades (rotor blades), the rotational speed of the agitating blades is, for example, about 200 to 5000 rpm.

### Electrode Active Material

In this embodiment, the electrode active material has at least one type of functional group selected from hydroxy group (—OH), carbonyl group (═CO), and carboxyl group (—COOH) on its surface. It is sufficient if the electrode active material contained in the granulated material has the above-indicated functional group(s) on its surface when it is used in the manufacture of electrodes, etc. as described later.

The method of manufacturing the granulated material according to the embodiment preferably includes a process of performing plasma treatment on the electrode active material. By performing plasma treatment on the electrode active material, at least one type of functional group selected from the hydroxy group, carbonyl group, and carboxyl group is formed on the surface of the electrode active material, due to a trace amount of organic matter attached to the surface of the electrode active material. It is possible to confirm the presence of the functional groups, by checking the presence or absence of characteristic absorption of the functional groups using an infrared spectrum for the electrode active material.

The plasma treatment is a surface treatment that uses plasma to clean or treat material surfaces. Plasma is the fourth state of matter following solid, liquid, and gas. Plasma is, for example, a state in which the molecules that make up gas are ionized and split into cations and electrons, and are in motion. Plasma includes atmospheric plasma as plasma generated under atmospheric pressure, and vacuum plasma as plasma generated in a vacuum. Plasma also includes non-neutral plasma, strongly coupled plasma (fine particle plasma, solid plasma), and so forth.

The plasma treatment to the electrode active material may be performed in advance on the electrode active material before the manufacture of the granulated material, or may be performed on the granulated material containing the electrode active material after the manufacture of the granulated material (after mixing the electrode active material, binder, solvent, etc.).

When the plasma treatment is performed in advance on the electrode active material before the manufacture of the granulated material, it is preferable to carry out the manufacture of the granulated material (mixing of the electrode active material, binder, solvent, etc.) as soon as possible, after performing the plasma treatment. This is because, if the electrode active material is stored in air, for example, after plasma treatment is performed on the electrode active material, other functional groups may be formed on the surface of the electrode active material due to the components in the air, which may reduce the wettability of the electrode active material.

After the manufacture of the granulated material (after mixing of the electrode active material, binder, solvent, etc.), the surface of the electrode active material is already wetted by the solvent (or a mixture of the solvent and the binder); therefore, at least one type of functional group selected from the hydroxy group, carbonyl group, and carboxyl group formed on the surface of the electrode active material can be relatively stable. Thus, the plasma treatment may be performed on the granulated material containing the electrode active material after the manufacture of the granulated material (after mixing of the electrode active material, binder, solvent, etc.).

The electrode active material may be a positive-electrode active material or a negative-electrode active material. The electrode active material may be in particle form or may be porous active material particles formed by aggregation of primary particles consisting of electrode active material.

Examples of the positive-electrode active material include lithium-containing metal oxides, lithium-containing phosphates, and so forth. The lithium-containing metal oxides include, for example, LiCoO₂, LiNiO₂, compounds represented by the general formula LiNiₐCo_{b}O₂ (where a+b=1, 0<a<1, and 0<b<1), LiMnO₂, LiMn₂O₄, compounds represented by the general formula LiNiₐCo_{b}Mn_{c}O₂ (where a+b+c=1, 0<a<1, 0<b<1, and 0<c<1), LiFePO₄, etc. Here, one example of the compounds represented by the general formula LiNiₐCo_{b}Mn_{c}O₂ is LiNi_{1/3}Co_{1/3}Mn_{1/3}O₂. The lithium-containing phosphates include, for example, LiFePO₄, etc.

The average particle diameter of the positive-electrode active material is, for example, about 1 to 25 μm. The “average particle diameter” mentioned herein means the particle diameter (D50) at 50% integrated value in the volume-based particle size distribution measured by the laser diffraction and scattering method.

Examples of the negative-electrode active material include carbon-based negative-electrode active materials, such as graphite, easily graphitizable carbon, and hardly graphitizable carbon, and alloy-based negative-electrode active materials containing silicon (Si), tin (Sn), etc. The average particle diameter (D50) of the negative-electrode active material may be, for example, about 1 to 25 μm.

The ratio of the electrode active material to the total solid content of the granulated material (i.e. the content percentage of the electrode active material in the electrode composite layer) is, for example, about 94 to 99.7 mass %.

### Binder

Examples of the binder include carboxymethyl cellulose (CMC), styrene butadiene rubber (SBR), polyvinylidene fluoride (PVDF), polytetrafluoroethylene (PTFE), and polyacrylic acid (PAA). One type of binder may be used alone, or two or more types of binders may be used in combination.

The ratio of the binder to the total solid content of the granulated material (i.e., the content percentage of the binder in the electrode composite layer) is, for example, about 0.3 to 6 mass %.

### Solvent

Examples of the solvent include aqueous solvent and organic solvent. The aqueous solvent means water, or mixed solvent containing water and polar organic solvent.

As an aqueous solvent, water can be suitably used for ease of handling. Examples of the polar organic solvent that can be used in the mixed solvent include, for example, alcohols such as methanol, ethanol, and isopropyl alcohol, ketones such as acetone, and ethers such as tetrahydrofuran. The aqueous solvent can be suitably used as solvent for the manufacture of negative electrodes.

Examples of the organic solvent include N-methyl-2-pyrrolidone (NMP), etc. The organic solvent can be suitably used as solvent for the manufacture of positive electrodes.

While the amount of the solvent used is not limited to any particular amount, the solid content percentage (the non-volatile content percentage) of the granulated material is preferably 75 to 90 mass %, more preferably 80 to 86 mass %, even more preferably 82 to 84 mass %. In this case, the granulated material retains liquid well, and an electrode composite layer 12 can be more reliably transferred to an electrode current collector 13 on a third roll 33, in a placement process (S30) that will be described later. In this connection, the “solid content percentage” means the ratio of the mass of components (non-volatile components) other than the solvent to the total mass of all raw materials including the solvent.

Furthermore, in this case, the granulated material has both good spreadability and good liquid retainability, which facilitates the manufacture of electrodes using the granulated material, and improves the productivity in the manufacture of electrodes.

Conventionally, in order to obtain granulated material having both desirable spreadability and liquid retainability to improve the productivity in the manufacture of electrodes, adjustment of the types of materials constituting the granulated material, mixing ratio, etc. has been considered. However, it was difficult for such adjustment to achieve the granulated material having both desirable spreadability and liquid retainability.

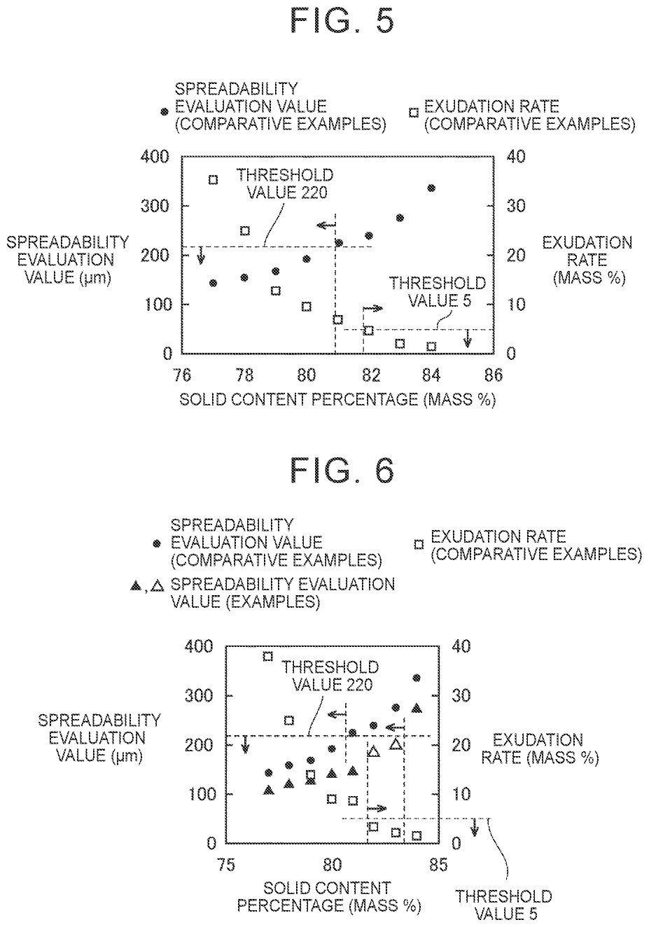

More specifically, a condition of spreadability of the granulated material necessary for easy manufacture of electrodes is, for example, that the spreadability evaluation value (see Examples below) is equal to or smaller than a specified threshold value (220 μm). The threshold value of the spreadability evaluation value is obtained from the results of production of electrodes actually using granulated materials having various degrees of spreadability, and is determined so as to prevent unevenness (non-uniformity) and transparency (deficiency) in the electrode composite layer provided on the electrode current collector. A condition of liquid retainability of the granulated material necessary for easy production of electrodes is, for example, that the exudation rate (see Examples below) is equal to or less than a specified threshold value (5 mass %). The threshold value of the exudation rate is obtained from the results of production of electrodes actually using granulated materials having various degrees of spreadability, and is determined so that the electrode composite layer is sufficiently attached to the electrode current collector. FIG. 5 is a graph showing the relationship between the solid content percentage, spreadability evaluation value, and exudation rate, for conventional granulated materials (granulated materials of Comparative Examples 1-8 as described later) that are not subjected to plasma treatment. Referring to FIG. 5, the solid content percentage of the granulated material when the spreadability evaluation value of the granulated material is equal to or smaller than the threshold value (220 μm) is less than about 81%. In the meantime, the solid content percentage of the granulated material when the liquid retainability of the granulated material is equal to or less than the threshold value (5 mass %) is equal to or above about 82 mass %. Thus, it is found difficult to obtain granulated material of which both the spreadability (spreadability evaluation value) and the liquid retainability (exudation rate) satisfy conditions necessary for easy production of electrodes, only through adjustment of the material composition, etc. in the conventional granulated material.

On the other hand, the method of manufacturing the granulated material according to this embodiment makes it possible to obtain granulated material having both good spreadability and good liquid retainability, which can facilitate the manufacture of electrodes and improve the productivity (see Examples that will be described later, in particular, Examples 6 and 7 indicated by white triangles in FIG. 6).

### Other Components

The granulated material may contain other components, such as a conductive material, than those as indicated above. Examples of the conductive material include, for example, carbon blacks, such as acetylene black (AB), thermal black, and furnace black. With the conductive material thus contained, the electron conductivity is expected to be improved.

### Method of Manufacturing Electrodes

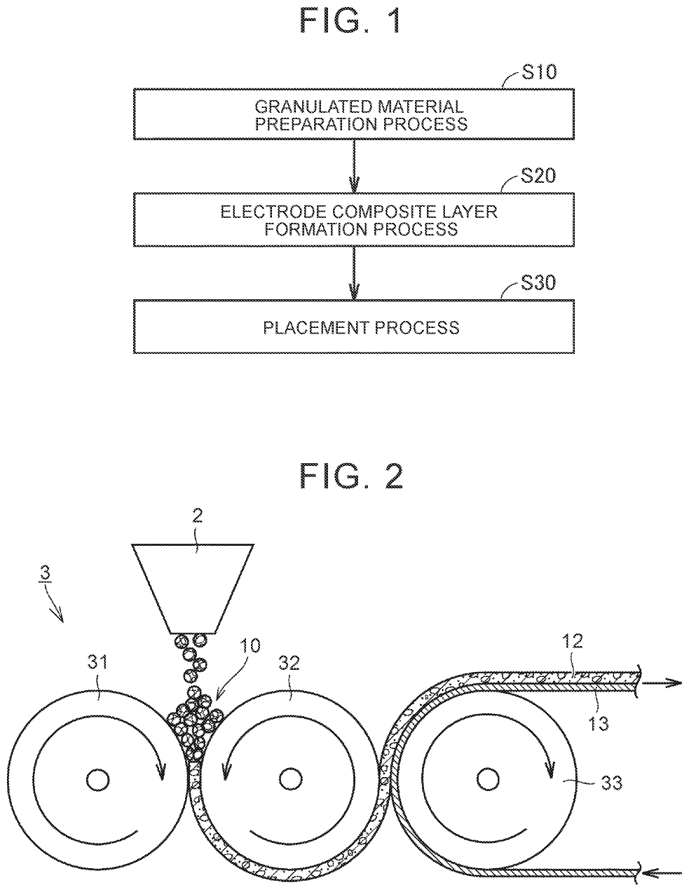

FIG. 1 is a flowchart schematically showing the method of manufacturing electrodes according to the embodiment. As shown in FIG. 1, the electrode manufacturing method of this embodiment includes at least the granulated material preparation process (S10), electrode composite layer formation process (S20), and placement process (S30).

The electrodes manufactured in this embodiment are, for example, sheet-like electrodes (electrode sheets) used for lithium-ion secondary batteries. The electrodes may be either positive electrodes or negative electrodes.

### Granulated Material Preparation Process (S10)

In the granulated material preparation process, the granulated material containing the electrode active material, binder, and solvent is prepared by the above method of manufacturing the granulated material.

### Electrode Composite Layer Formation Process (S20)

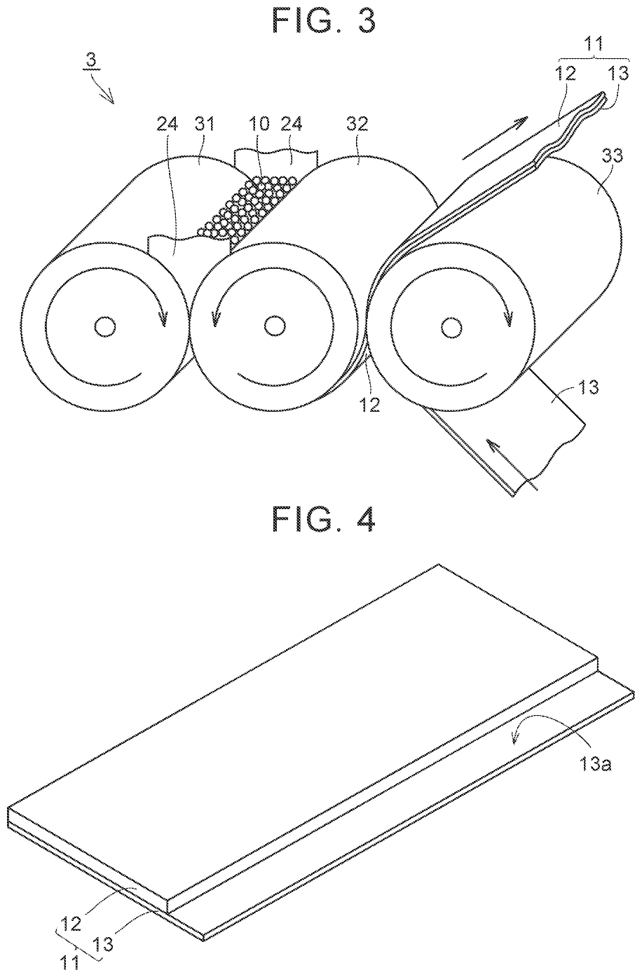

In the electrode composite layer formation process, the granulated material is subjected to compression molding with a pair of rolls, to form the electrode composite layer. For example, the granulated material obtained in the above granulated material preparation process is supplied between a pair of rolls that are arranged in parallel with each other with a spacing therebetween and are respectively rotated, and the granulated material is compressed between the pair of rolls, to form the electrode composite layer. More specifically, as shown in FIG. 2 and FIG. 3, the granulated material 10 is supplied to a first gap between a first roll 31 and a second roll 32, and the granulated material 10 is subjected to compression molding so that the electrode composite layer 12 is formed.

In the electrode manufacturing method of this embodiment, an electrode manufacturing apparatus 3 as shown in FIG. 2 and FIG. 3 is used. The electrode manufacturing apparatus 3 includes a feeder 2 and three rolls (first roll 31, second roll 32, third roll 33). The diameter of each of the first roll 31, second roll 32, and third roll 33 is, for example, 10 to 1000 mm, and the axial length of each of the rolls is, for example, 100 to 2000 mm.

The respective rotational axes of the first roll 31, second roll 32, and third roll 33 are fixed such that the respective rotational axes of the first roll 31, second roll 32, and third roll 33 are parallel to each other. The distance (width) of the first gap between the first roll 31 and the second roll 32 is kept constant. The distance of the second gap between the second roll 32 and the third roll 33 is also kept constant. The first roll 31, second roll 32, and third roll 33 are respectively driven to be rotated. In FIG. 2 and FIG. 3, the curved arrow depicted in each roll indicates the rotational direction of each roll.

The first roll 31 and the second roll 32 are rotated in opposite directions. The granulated material is supplied between the pair of rolls (first roll 31 and second roll 32), and the granulated material is subjected to compression molding with the pair of rolls, to form the sheet-like electrode composite layer.

The distance of the first gap is, for example, about 50 μm to 10 mm. The distance of the first gap is the linear distance between the first roll 31 and the second roll 32 at the position where the first roll 31 and the second roll 32 are closest to each other.

The feeder 2 is located right above the first gap between the first roll 31 and the second roll 32. In this process, first, the granulated material is supplied to the feeder 2. The feeder 2 supplies the granulated material 10 to the first gap.

The electrode manufacturing apparatus 3 further includes a pair of restriction plates 24 that are arranged in parallel with each other, with a predetermined spacing in the axial direction of the first roll 31 and the second roll 32. The granulated material 10 supplied to the first gap is drawn downward of the first gap and passes through the first gap as the first roll 31 and the second roll 32 rotate (in the directions of the arrows in FIG. 2), with its width dimension limited by the pair of restriction plates 24. In this manner, the amount (mass per unit area) of the electrode composite layer 12 can be adjusted. With the pair of restriction plates 24 thus provided, exposed portions 13a on which the electrode composite layer 12 is not placed can be provided at the widthwise opposite ends of the electrode current collector 13 (see FIG. 4). The amount of the electrode composite layer 12 can also be adjusted by the distance of the first gap.

The rotational speed of the second roll 32 is preferably faster than the rotational speed of the first roll 31. For example, the rotational speed of the second roll 32 is about three times to five times the rotational speed of the first roll 31. By making the rotational speed of the second roll 32 faster than the rotational speed of the first roll 31, the granulated material is stretched more on the surface of the second roll 32 than on the surface of the first roll 31, as shown in FIG. 2, and the area of a liquid cross-linking portion of the granulated material in contact with the surface of the second roll 32 is larger than the area of that in contact with the surface of the first roll 31. As a result, the granulated material 10 (electrode composite layer 12) after rolling sticks to the second roll 32 side, and is conveyed by the second roll 32.

### Placement Process (S30)

In the placement process, the electrode composite layer 12 is placed on the electrode current collector 13. For example, the sheet-like electrode composite layer 12 produced in the electrode composite layer formation process (S20) is transferred to the electrode current collector 13 (negative-electrode current collector), so that the electrode composite layer 12 is placed on the electrode current collector 13.

More specifically, as shown in FIG. 2 and FIG. 3, the electrode current collector 13 is conveyed on the third roll 33, and supplied to the second gap between the second roll 32 and the third roll 33. The electrode composite layer 12, after leaving the first gap between the first roll 31 and the second roll 32, is conveyed on the second roll 32, and supplied to the second gap. The second roll 32 and the third roll 33 are rotated in opposite directions (see the curved arrows in FIG. 2 and FIG. 3).

In the gap between the second roll 32 and the third roll 33, the electrode composite layer 12 is pressed against the electrode current collector 13, and adheres to the electrode current collector 13, away from the second roll 32. Namely, the electrode composite layer 12 is transferred from the second roll 32 to the electrode current collector 13. Thus, the electrode composite layer 12 conveyed on the second roll 32 and the electrode current collector 13 conveyed on the third roll 33 are supplied to the second gap between the second roll 32 and the third roll 33, so that the electrode composite layer 12 is placed on the electrode current collector 13, to form an electrode sheet 11.

After the electrode composite layer 12 is dried, the electrode sheet 11 may be cut to a predetermined size using, for example, a slitter.

The electrode obtained by the manufacturing method of the disclosure can be used, for example, as an electrode of a secondary battery, such as a lithium-ion secondary battery (non-aqueous electrolyte secondary battery). The secondary battery, such as the lithium-ion secondary battery, can be used, for example, as a power supply of a hybrid electric vehicle (HEV), battery electric vehicle (BEV), plug-in hybrid electric vehicle (PHEV), or the like. However, the electrode obtained by the manufacturing method of the disclosure is not limited to such automotive applications, but can be applied to any use.

This embodiment will be described using some examples. However, the embodiment is not limited to these examples.

### EXAMPLES 1 TO 8

Granulated materials (granulated materials for positive-electrode composite layers) of Examples 1 to 8 were produced in the following manner.

In Examples 1 to 8, the following materials were prepared.

Positive-electrode active material: NCM (lithium nickel cobalt manganate) (average particle diameter (D50): 6 μm)
Binder: polyvinylidene fluoride (PVDF)

First, plasma treatment was performed on the positive-electrode active material. Specifically, atmospheric pressure plasma discharge (condition: 10 kV) was performed for one min. on the positive-electrode active material.

The positive-material active material (95 mass %), auxiliary agent (AB: 3.5 mass %), binder (PVDF: 1.5 mass %), and solvent (NMP) were put into an agitation tank of a mixer (agitation granulator), and mixed together, to prepare granulated material. The amount of the solvent used was adjusted so that the solid content concentration of the granulated material was equal to 77, 78, 79, 80, 81, 82, 83 and 84 mass %, respectively, in Examples 1 to 8.

### COMPARATIVE EXAMPLES 1 TO 8

In Comparative Examples 1 to 8, the plasma treatment was not performed. Otherwise, the granulated materials of Comparative Examples 1 to 8 were produced in the same manners as in Examples 1 to 8, respectively.

### Spreadability Evaluation

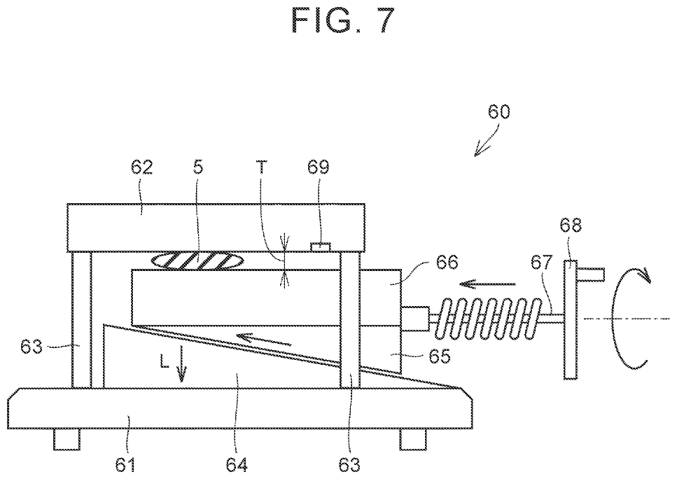

The granulated materials of Examples 1 to 8 and Comparative Examples 1 to 8 were evaluated for spreadability. Specifically, the spreadability was evaluated in the following manner, using a spreadability evaluation device 60 as shown in FIG. 7.

As shown in FIG. 7, the spreadability evaluation device 60 has a platform 61 with load cell. An upper plate 62 is fixed to the platform 61 with load cell via posts 63, 63. A lower wedge member 64 and an upper wedge member 65 are placed on the platform 61 with load cell. Each of the lower wedge member 64 and the upper wedge member 65 has a slope inclined at a predetermined angle, and the slope of the lower wedge member 64 and the slope of the upper wedge member 65, which are opposed to each other, are superposed on each other. On the upper wedge member 65, a lower moving plate 66 is installed such that it is integrated with the upper wedge member 65.

When a rotary shaft 67 is rotated with a handle 68, and the upper wedge member 65 and the lower moving plate 66 are moved to the left in FIG. 7, using a moving mechanism (not shown), the upper wedge member 65 and the lower moving plate 66 move along the slope of the lower wedge member 64, and also move upward. Namely, when the lower moving plate 66 moves to the left in FIG. 7 by a predetermined distance, it also rises upward in FIG. 7 by a predetermined level. In the spreadability evaluation device 60 used in the embodiment, the angles of the slopes of the lower wedge member 64 and the upper wedge member 65 are set so that the lower moving plate 66 is lifted upward by 40 μm when the lower moving plate 66 is moved to the left (in the horizontal direction) in FIG. 7 by 15 mm.

When evaluating the granulated material 10, first, 0.5 g of the granulated material 10 (a plurality of particles of the granulated material) is placed on the lower moving plate 66 of the spreadability evaluation device 60. Then, the handle 68 is rotated, so that the lower moving plate 66 is moved to the left in FIG. 7 at a speed of 15 mm/sec., and is lifted at a speed of 40 μm/sec. As a result, the granulated material 10 on the lower moving plate 66 is spread between the upper plate 62 and the lower moving plate 66 while shearing force is applied to the granulated material 10, to form a granulated film 5.

During this spreading, the reaction force of the spreading of the granulated film 5 is applied to the platform 61 with load cell via the lower moving plate 66, upper wedge member 65, and lower wedge member 64, and the reaction force is measured as a load L. Also, the upper plate 62 is provided with a displacement sensor 69 that measures the distance between the upper plate 62 and the lower moving plate 66, namely, the thickness T of the granulated film 5.

For the granulated materials of Examples and Comparative Examples, the thickness T (μm) of the granulated film 5 at the time when the load L was equal to 6.5 kN during movement of the upper wedge member 65 and the lower moving plate 66 to the left in FIG. 7 was measured as the spreadability evaluation value. As the spreadability evaluation value (μm) is smaller, the spreadability of the granulated material is higher (the granulated material is more likely to spread). The measurement results of the spreadability evaluation (μm) of Examples and Comparative Examples are indicated in FIG. 6.

### Liquid Retainability Evaluation

For the granulated materials of Comparative Examples 1 to 8, the exudation rate (mass %) as an indicator of the liquid retainability was measured when the granulated material was compressed. The exudation rate (mass %) is the percentage of the amount of solvent exuded when the granulated material is compressed to a density of 1.6 g/cc using a hydraulic press. The exudation rate is calculated according to the following expression.

(“Amount of solvent contained in granulated material before compression”−“Amount of solvent contained in granulated material after compression”)/“Amount of solvent contained in granulated material before compression”

As the exudation rate (mass %) is smaller, the liquid retainability of the granulated material is higher.

The measurement results of the exudation rate (mass %) of the granulated materials of Comparative Examples 1 to 8 are shown in FIG. 6. Since the liquid retainability is mainly determined by the solid content percentage of the granulated material, the liquid retainability of the granulated material of each of Examples 1 to 8 is considered to be substantially equal to the liquid retainability of the granulated material of each of Comparative Examples 1 to 8.

It is understood from the results shown in FIG. 6 that the spreadability is improved in the granulated materials of Examples 1 to 8, compared to the granulated materials of Comparative Examples 1 to 8.

As described above with reference to FIG. 5, it was difficult to obtain granulated material of which both the spreadability and the liquid retainability satisfy conditions necessary for easy manufacture of electrodes, only through adjustment of the material composition, etc. in conventional granulated materials (those of Comparative Examples). On the other hand, the granulated materials of Examples have improved spreadability while maintaining the liquid retainability, thus making it possible to obtain granulated material having both good spreadability and good liquid retainability (see Examples 6 and 7 indicated by white triangles in FIG. 6), which facilitates manufacture of electrodes and improves productivity.

It is to be understood that the embodiment and examples disclosed herein are exemplary in all respects, and are not restrictive. The scope of the disclosure is indicated by the claims, rather than the above description, and is intended to include all changes within the claims and the meaning and range of equivalents thereof.

What is claimed is:

1. A method of manufacturing a granulated material containing an electrode active material, a binder, and a solvent, comprising
preparing the electrode active material such that at least one type of functional group selected from hydroxy group, carbonyl group, and carboxyl group is included on a surface of the electrode active material.

2. The method according to claim 1, further comprising performing plasma treatment on the electrode active material.

3. The method according to claim 1, wherein the granulated material has a solid content percentage that is equal to or greater than 75 mass % and is equal to or less than 90 mass %.

4. A method of manufacturing an electrode, comprising:
preparing a granulated material containing an electrode active material, a binder, and a solvent, the electrode active material being prepared such that at least one type of functional group selected from hydroxy group, carbonyl group, and carboxyl group is included on a surface of the electrode active material;
performing compression molding on the granulated material with a pair of rolls, to form an electrode composite layer; and
placing the electrode composite layer on an electrode current collector.
